(19) United States
(12) Patent Application Publication
(10) Pub. No.: US 2020/0079327 A1
(43) Pub. Date: Mar. 12, 2020

(54) FUEL CELL VEHICLE

(71) Applicant: TOYOTA JIDOSHA KABUSHIKI KAISHA, Toyota-shi (JP)

(72) Inventor: Kunihiko Toyofuku, Toyota-shi (JP)

(73) Assignee: TOYOTA JIDOSHA KABUSHIKI KAISHA, Toyota-shi (JP)

(21) Appl. No.: 16/515,494

(22) Filed: Jul. 18, 2019

(30) Foreign Application Priority Data
Sep. 10, 2018 (JP) 2018-168400

(51) Int. Cl. B60S 1/50; H01M 8/04291; B08B 3/02; H01M 8/04746; B60L 50/70; B60S 1/52; G02B 27/00

(52) U.S. Cl. CPC B60S 1/50; H01M 8/04291; B08B 3/02; H01M 8/04761; B60Y 2400/202; B60S 1/52; G02B 27/0006; H01M 2250/20; B60Y 2200/91; B60L 50/70

(57) ABSTRACT

A fuel cell vehicle includes an electric motor that generates a drive force, a fuel cell that generates electric power to be supplied to the electric motor, a water storage tank that stores generated water, a water quantity detector that detects the quantity of the generated water in the water storage tank, a generated water injection nozzle connected to the water storage tank via a pipeline and disposed so as to face a cleaning object, a pump that supplies the generated water in the water storage tank to the generated water injection nozzle, and a pump control device that controls the pump such that the generated water is supplied to the generated water injection nozzle and injected toward the cleaning object when the pump control device determines that the water quantity detected by the water quantity detector has become equal to or greater than a predetermined threshold water quantity.

### INCORPORATION BY REFERENCE

The disclosure of Japanese Patent Application No. 2018-168400 filed on Sep. 10, 2018 including the specification, drawings and abstract is incorporated herein by reference in its entirety.

### BACKGROUND

### 1. Technical Field

The present disclosure relates to a fuel cell vehicle that is provided with a fuel cell which generates electric power by causing a chemical reaction between hydrogen and oxygen.

### 2. Description of Related Art

A fuel cell vehicle (hereinafter, referred to as “FC vehicle” in some cases) is provided with a fuel cell generating electric power by causing a chemical reaction between hydrogen and oxygen and an electric motor as a vehicle drive source operating by using the electric power that the fuel cell generates. An FC vehicle that is provided with a water storage tank which temporarily stores generated water generated when a fuel cell generates electric power is known (in, for example, Japanese Unexamined Patent Application Publication No. 2005-108529 (JP 2005-108529 A)).

Conceivable is providing this type of FC vehicle with a generated water injection nozzle connected to the water storage tank via a pipeline having a pump and facing a camera (cleaning object) provided in the vehicle and a dirt detection sensor detecting the dirt on the surface of the camera. In this FC vehicle, the pump operates once the dirt detection sensor detects the dirt on the camera surface. Then, the generated water in the water storage tank pressurized by the pump is sent to the generated water injection nozzle via the pipeline and the generated water is injected from the generated water injection nozzle toward the camera. As a result, the dirt on the camera surface is removed by the injected generated water.

### SUMMARY

The FC vehicle may be provided with a plurality of cameras. In this case, a plurality of generated water injection nozzles and a plurality of dirt detection sensors need to be provided correspondingly to the respective cameras. Once the dirt detection sensors simultaneously detect the dirt on the respective corresponding cameras in this FC vehicle, generated water is simultaneously injected from each of the generated water injection nozzles toward corresponding one of the cameras as a result of pump operation.

A water storage tank needs to store a large amount of generated water for simultaneously supplying a sufficient amount of the generated water for cleaning to all of the generated water injection nozzles. In other words, the capacity of a water storage tank needs to be increased in this case.

The present disclosure provides a fuel cell vehicle in which the capacity of a water storage tank for storing generated water can be reduced even in a case where the fuel cell vehicle has a plurality of generated water injection nozzles injecting generated water produced during electric power generation and a plurality of cleaning objects that is cleaned by the generated water injected from the generated water injection nozzles.

An aspect of the present disclosure relates to a fuel cell vehicle. The fuel cell vehicle includes an electric motor, a fuel cell, a water storage tank, a water quantity detector, a generated water injection nozzle, a pump, and a pump control device. The electric motor is configured to generate a drive force for rotating a drive wheel of the fuel cell vehicle. The fuel cell is configured to generate electric power to be supplied to the electric motor by causing a chemical reaction between hydrogen and oxygen. The water storage tank is configured to store generated water generated when the fuel cell generates the electric power. The water quantity detector is configured to detect a quantity of the generated water in the water storage tank. The generated water injection nozzle is connected to the water storage tank via a pipeline and disposed so as to face a cleaning object provided at a part of the fuel cell vehicle. The pump is configured to supply the generated water in the water storage tank to the generated water injection nozzle via the pipeline. The pump control device is configured to control the pump such that the generated water is supplied to the generated water injection nozzle and the generated water is injected from the generated water injection nozzle toward the cleaning object when the pump control device determines that the quantity of the generated water detected by the water quantity detector has become equal to or greater than a predetermined threshold water quantity.

According to the aspect of the present disclosure, the pump control device operates the pump when the pump control device determines that the water quantity detected by the water quantity detector has become equal to or greater than the threshold water quantity. Then, the generated water is supplied to the generated water injection nozzle and the generated water is injected toward the cleaning object from the generated water injection nozzle. In other words, the pump control device operates the pump, without considering the state of the dirt on the cleaning object, once the quantity of the generated water in the water storage tank becomes equal to or greater than the threshold water quantity. Accordingly, it is possible to reduce the capacity of the water storage tank by, for example, setting the threshold water quantity to a generated water quantity needed for cleaning of one cleaning object.

In the fuel cell vehicle according to the aspect of the present disclosure, a plurality of the cleaning objects may be provided and a plurality of the generated water injection nozzles may be disposed such that each of the generated water injection nozzles faces a corresponding one of the cleaning objects. The pump control device may be configured to control the pump such that the generated water is supplied to a part of the generated water injection nozzles and the generated water is injected from the part of the generated water injection nozzles toward a part of the cleaning objects when the pump control device determines that the quantity of the generated water detected by the water quantity detector has become equal to or greater than the predetermined threshold water quantity.

According to the aspect of the present disclosure, the cleaning objects can be cleaned by the generated water. Since the generated water is not simultaneously supplied to all of the generated water injection nozzles, the capacity of the water storage tank can be smaller than in a case where generated water is simultaneously supplied to every generated water injection nozzle.

The fuel cell vehicle according to the aspect of the present disclosure may further include a compressed air injection nozzle disposed so as to face the cleaning object and connected to an air compressor via an air pipeline and a compressor control device configured to control the air compressor such that compressed air is pumped to the compressed air injection nozzle and the compressed air is injected from the compressed air injection nozzle toward the cleaning object after the generated water is injected toward the cleaning object by the generated water injection nozzle.

According to the aspect of the present disclosure, the compressed air injected from the compressed air injection nozzle is sprayed to the cleaning object after the generated water is injected toward the cleaning object by the generated water injection nozzle. Accordingly, it is possible to quickly remove the generated water adhered to the cleaning object from the cleaning object.

The fuel cell vehicle according to the aspect of the present disclosure may further include an air compressor connected to the generated water injection nozzle via the pipeline and a compressor control device configured to control the air compressor such that compressed air is injected from the generated water injection nozzle toward the cleaning object by the compressed air being pumped to the generated water injection nozzle simultaneously with the injection of the generated water by the generated water injection nozzle.

According to the aspect of the present disclosure, the compressed air injected from the generated water injection nozzle is sprayed to the cleaning object at the same time as the generated water injection nozzle injects the generated water toward the cleaning object. Accordingly, it is possible to quickly remove the generated water adhered to the cleaning object from the cleaning object.

In the fuel cell vehicle according to the aspect of the present disclosure, the pump control device may be configured to control the pump such that the generated water is supplied to the generated water injection nozzle and the generated water is injected from the generated water injection nozzle toward the cleaning object when the pump control device determines that the quantity of the generated water detected by the water quantity detector has become equal to or greater than the predetermined threshold water quantity and the fuel cell vehicle stops for a predetermined needed transited time.

According to the aspect of the present disclosure, the generated water injection nozzle injects no generated water toward the cleaning object without a determination that the fuel cell vehicle stops for the needed transited time. Accordingly, in a case where the cleaning object is, for example, a camera that is used during traveling of the fuel cell vehicle, the fuel cell vehicle stops for the needed transited time once the generated water is injected to the camera. Then, gravity or the like is likely to cause the generated water to almost disappear from the surface of the camera during the needed transited time. Accordingly, the camera is unlikely to become incapable of capturing a clear subject image due to the generated water during traveling of the fuel cell vehicle even in a case where the fuel cell vehicle is provided with no air compressor.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic block diagram of a fuel cell, a cleaning system, and a compressed air supply system of a fuel cell vehicle according to an embodiment of the present disclosure;

FIG. 2 is a flowchart illustrating processing that is executed by a cleaning control ECU of the embodiment of the present disclosure; and

FIG. 3 is a flowchart illustrating processing that is executed by a cleaning control ECU of a modification example of the present disclosure.

### DETAILED DESCRIPTION OF EMBODIMENTS

Hereinafter, an FC vehicle according to an embodiment of the present disclosure will be described with reference to accompanying drawings.

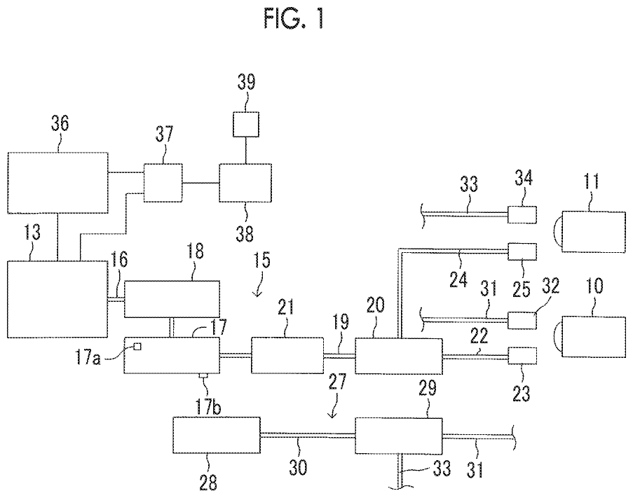

The FC vehicle of the present embodiment is provided with a front camera 10 and a rear camera 11 illustrated in FIG. 1. The front camera 10 is provided in the vehicle-width-direction middle portion of a front grill (not illustrated) provided in the front portion of the vehicle. The rear camera 11 is provided on the surface of a back door that is on the outer side of the vehicle (rear surface). The back door (not illustrated) is provided in the rear portion of the vehicle.

The FC vehicle is provided with an electric motor (not illustrated), which is a drive wheel drive source, and a fuel cell 13 illustrated in FIG. 1 and generating electric power to be supplied to the electric motor. As is well known, the fuel cell 13 is provided with a fuel cell stack configured by a plurality of single cells being stacked. The fuel cell 13 generates the electric power by causing a reaction between hydrogen and oxygen as described later.

As illustrated in FIG. 1, a cleaning system 15 is connected to the fuel cell 13. The cleaning system 15 is provided with a tank water supply pipeline 16, a water storage tank 17, a moisture collector 18, a generated water pipeline 19, a first switching valve 20, a pump 21, a first generated water injection pipeline 22, a first generated water injection nozzle 23, a second generated water injection pipeline 24, and a second generated water injection nozzle 25.

The fuel cell 13 is connected to the water storage tank 17 via the tank water supply pipeline 16. The tank water supply pipeline 16 is provided with the moisture collector 18, which is positioned between the fuel cell 13 and the water storage tank 17.

A water level sensor 17a for detecting the water quantity (water level) of the generated water in the water storage tank 17 is provided in the water storage tank 17. A hole (not illustrated) is formed in the bottom portion of the water storage tank 17. A plug 17b detachably blocks the hole. When a water drain switch (not illustrated) provided in the vehicle is not operated, the plug 17b blocks the hole of the water storage tank 17. The plug 17b opens the hole of the water storage tank 17 once an occupant operates the water drain switch. The water drain switch and the plug 17b are manual and operate without using electric power. An overflow discharge hole (not illustrated) is provided in the upper portion of the water storage tank 17. Once the generated water is supplied from the tank water supply pipeline 16 to the water storage tank 17 in a state where the water storage tank 17 is completely filled with the generated water, the generated water in the water storage tank 17 is discharged to the outside from the overflow discharge hole.

The water storage tank 17 is connected to the electrically operated first switching valve 20 via the generated water pipeline 19. The generated water pipeline 19 is provided with the electrically operated pump 21, which is positioned between the water storage tank 17 and the first switching valve 20.

The first generated water injection nozzle 23 is connected to the first switching valve 20 via the first generated water injection pipeline 22. The front grill is provided with the first generated water injection nozzle 23 such that the first generated water injection nozzle 23 faces the front camera 10. The first generated water injection nozzle 23 does not inject the supplied generated water when the pressure of the generated water supplied via the first generated water injection pipeline 22 is equal to or less than a predetermined first pressure value. The first generated water injection nozzle 23 injects the supplied generated water toward the front camera 10 when the pressure of the supplied generated water exceeds the predetermined first pressure value.

The second generated water injection nozzle 25 is connected to the first switching valve 20 via the second generated water injection pipeline 24. The second generated water injection nozzle 25 is provided on the back door surface on the outer side of the vehicle so as to face the rear camera 11. The second generated water injection nozzle 25 does not inject the supplied generated water when the pressure of the generated water supplied via the second generated water injection pipeline 24 is equal to or less than the predetermined first pressure value. The second generated water injection nozzle 25 injects the supplied generated water toward the rear camera 11 when the pressure of the supplied generated water exceeds the predetermined first pressure value.

The first switching valve 20 is switchable between a first state and a second state. In the first state, the first switching valve 20 allows the generated water to flow between the generated water pipeline 19 and the first generated water injection pipeline 22 and regulates a flow of the generated water between the generated water pipeline 19 and the second generated water injection pipeline 24. In the second state, the first switching valve 20 regulates a flow of the generated water between the generated water pipeline 19 and the first generated water injection pipeline 22 and allows the generated water to flow between the generated water pipeline 19 and the second generated water injection pipeline 24. When the pump 21 is in a stop state (that is, in a non-operating state), a movement of the generated water in the water storage tank 17 to the first switching valve 20 side is regulated by the pump 21.

The FC vehicle is provided with a compressed air supply system 27 illustrated in FIG. 1 and independent of the cleaning system 15. The compressed air supply system 27 is provided with an air compressor 28, a second switching valve 29, a compressed air pipeline 30, a first compressed air injection pipeline 31, a first compressed air injection nozzle 32, a second compressed air injection pipeline 33, and a second compressed air injection nozzle 34.

The electrically operated second switching valve 29 is connected to the electrically operated air compressor 28 via the compressed air pipeline 30. The air compressor 28 supplies compressed air to the compressed air pipeline 30 once the air compressor 28 operates by receiving electric power supply.

A first end of the first compressed air injection pipeline 31 is connected to the second switching valve 29. The first compressed air injection nozzle 32 is connected to a second end of the first compressed air injection pipeline 31. The front grill is provided with the first compressed air injection nozzle 32 such that the first compressed air injection nozzle 32 faces the front camera 10. When the pressure of air supplied via the first compressed air injection pipeline 31 is equal to or less than a predetermined second pressure value, the first compressed air injection nozzle 32 does not inject the supplied air. The first compressed air injection nozzle 32 injects the supplied air toward the front camera 10 when the pressure of the supplied air exceeds the predetermined second pressure value.

A first end of the second compressed air injection pipeline 33 is connected to the second switching valve 29. The second compressed air injection nozzle 34 is connected to a second end of the second compressed air injection pipeline 33. The second compressed air injection nozzle 34 is provided on the back door surface on the outer side of the vehicle so as to face the rear camera 11. When the pressure of air supplied via the second compressed air injection pipeline 33 is equal to or less than the predetermined second pressure value, the second compressed air injection nozzle 34 does not inject the supplied air. The second compressed air injection nozzle 34 injects the supplied air toward the rear camera 11 when the pressure of the supplied air exceeds the predetermined second pressure value.

The second switching valve 29 is switchable between the first state and the second state. In the first state, the second switching valve 29 allows the compressed air to flow between the compressed air pipeline 30 and the first compressed air injection pipeline 31 and regulates a flow of the compressed air between the compressed air pipeline 30 and the second compressed air injection pipeline 33. In the second state, the second switching valve 29 regulates a flow of the compressed air between the compressed air pipeline 30 and the first compressed air injection pipeline 31 and allows the compressed air to flow between the compressed air pipeline 30 and the second compressed air injection pipeline 33.

As illustrated in FIG. 1, a secondary battery 36 is connected to the fuel cell 13. The fuel cell 13 and the secondary battery 36 are connected to a cleaning control ECU 38 (hereinafter, referred to as “ECU 38”) via a drive circuit 37. ECU is an abbreviation of Electronic Control Unit. The ECU is provided with a microcomputer including a storage device such as a random access memory (RAM), a read only memory (ROM), and a central processing unit (CPU). The CPU realizes various functions by executing an instruction (program) stored in the ROM. An ignition switch 39 (hereinafter, referred to as “IGSW 39”) and the water level sensor 17a are connected to the ECU 38. The drive circuit 37 is connected to the first switching valve 20, the pump 21, the air compressor 28, and the second switching valve 29.

Operation of the front camera 10, the rear camera 11, the fuel cell 13, the cleaning system 15, and the compressed air supply system 27 will be described below.

Once the IGSW 39 is switched from OFF to ON, the electric power stored in the secondary battery 36 is supplied to the electric motor and the electric motor is started. The electric power of the secondary battery 36 is supplied to the front camera 10 and the rear camera 11 via the drive circuit 37, and thus the front camera 10 and the rear camera 11 repeatedly execute imaging operation until the IGSW 39 is turned OFF. The water level sensor 17a repeatedly transmits a detected value to the ECU 38 until the IGSW 39 is turned OFF. At a time point when the IGSW 39 is switched from OFF to ON, no generated water is present in the water storage tank 17 and the hole is blocked by the plug 17b.

Once the IGSW 39 is switched from OFF to ON, hydrogen is supplied to the fuel cell 13 from a hydrogen tank (not illustrated) provided in the vehicle and the air (oxygen) outside the FC vehicle is supplied to the fuel cell 13 via an air supply path (not illustrated) from an intake port (not illustrated) provided at the front end of the FC vehicle. Then, electric power is generated by the hydrogen and the oxygen reacting with each other in the fuel cell 13 and water (hereinafter, referred to as “generated water”) is generated during the electric power generation. The generated water produced by the fuel cell 13 has a certain high temperature (such as approximately 60° C.). Once a predetermined condition is satisfied after the electric power is generated by the fuel cell 13, the electric power generated by the fuel cell 13 is supplied to the electric motor instead of the electric power of the secondary battery 36 and the electric power generated in the fuel cell 13 is stored in the secondary battery 36 as needed.

The generated water generated in the fuel cell 13 is supplied to the moisture collector 18 via the tank water supply pipeline 16. The moisture collector 18 is connected to a humidifier (not illustrated). The generated water supplied to the moisture collector 18 is partially supplied to the humidifier. The humidifier is connected to the air supply path. The air in the air supply path is humidified by the generated water supplied to the humidifier.

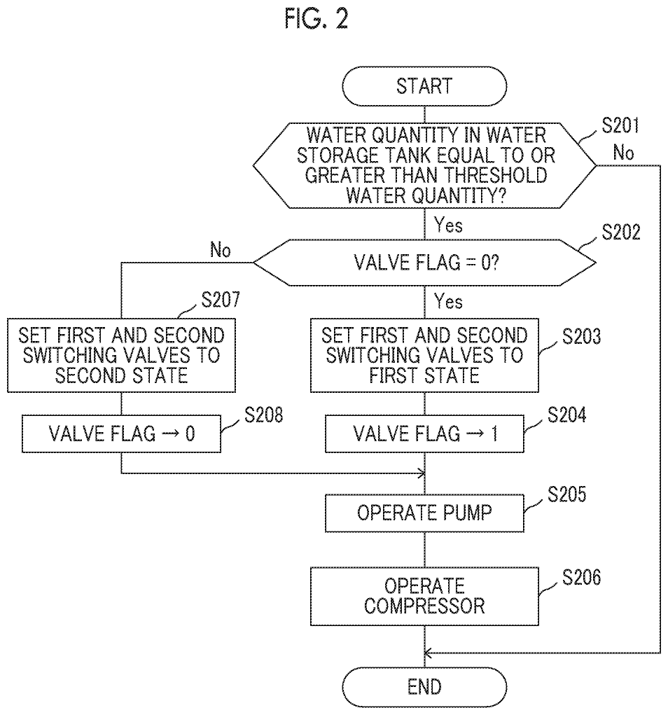

The generated water that is supplied to the moisture collector 18 and is not supplied to the humidifier is always supplied to the water storage tank 17 via the tank water supply pipeline 16. Once the IGSW 39 is turned ON in this manner, the generated water generated in the fuel cell 13 is continuously supplied to the water storage tank 17, and thus the water level (water quantity) of the generated water in the water storage tank 17 rises. The generated water stored in the water storage tank 17 is used for cleaning of the front camera 10 and the rear camera 11. The compressed air generated in the air compressor 28 is used for removal of the generated water that has adhered to the surfaces of the front camera 10 and the rear camera 11. The ECU 38 executes the generated water-based cleaning of the front camera 10 and the rear camera 11 and the compressed air-based generated water removal from the surfaces of the front camera 10 and the rear camera 11 by controlling the first switching valve 20, the pump 21, the air compressor 28, and the second switching valve 29. In other words, once the IGSW 39 is switched from OFF to ON, the ECU 38 repeatedly executes the processing of the flowchart illustrated in FIG. 2 every time a predetermined time transits. The processing of the flowchart of FIG. 2 by the ECU 38 will be described below.

When the IGSW 39 is switched from OFF to ON, both the first switching valve 20 and the second switching valve 29 are in the first state.

First, in Step S201, the ECU 38 determines, based on the detected value of the water level sensor 17a, whether or not the quantity of the generated water in the water storage tank 17 is equal to or greater than a predetermined threshold water quantity. The threshold water quantity is set to such an extent that the water storage tank 17 is substantially full of the generated water and drainage from the overflow discharge hole does not occur. In other words, the threshold water quantity is set to a generated water quantity at which the dirt on the surface of the front camera 10 and the dirt on the surface of the rear camera 11 can be sufficiently removed. In the present embodiment, the pump 21 is capable of discharging water by a predetermined quantity A (cc) per second (sec) and the threshold water quantity is set to A×B+C when the unit operation time of the pump 21 (first predetermined time to be described later) is B second(s) (sec) and the total value of the volumes of the spaces of the generated water pipeline 19, the first switching valve 20, the pump 21, and the first generated water injection pipeline 22 (through which the generated water passes) and the total value of the volumes of the spaces of the generated water pipeline 19, the first switching valve 20, the pump 21, and the second generated water injection pipeline 24 are C (cc).

The ECU 38 temporarily terminates the processing of this routine in the case of a No determination in Step S201.

The ECU 38 proceeds to Step S202 and determines whether or not a valve flag is “zero” in the case of a Yes determination in Step S201. The initial value of the valve flag is set to “zero”.

The ECU 38 proceeds to Step S203 and sets both the first switching valve 20 and the second switching valve 29 to the first state in the case of a Yes determination in Step S202. In a case where both the first switching valve 20 and the second switching valve 29 are already in the first state, the ECU 38 does not transmit the electric power of the secondary battery 36 to the first switching valve 20 and the second switching valve 29 as an operation signal via the drive circuit 37 in Step S203. In a case where both the first switching valve 20 and the second switching valve 29 are in the second state, the ECU 38 transmits the operation signal (electric power of the secondary battery 36) via the drive circuit 37 to the first switching valve 20 and the second switching valve 29 and switches the first switching valve 20 and the second switching valve 29 to the first state in Step S203.

The ECU 38 proceeds to Step S204 and sets the valve flag to “1” upon finishing the processing of Step S203.

Upon finishing the processing of Step S204, the ECU 38 proceeds to Step S205 and transmits the electric power of the secondary battery 36 to the pump 21 as the operation signal, via the drive circuit 37, and for the first predetermined time. Then, the pump 21 operates for the first predetermined time and the pressure generated by the pump 21 causes the generated water present in the water storage tank 17 at the time point immediately preceding the initiation of the processing of Step S205 to be supplied to the first generated water injection nozzle 23 via the generated water pipeline 19 and the first generated water injection pipeline 22. Then, the inner spaces of the generated water pipeline 19 and the first generated water injection pipeline 22 are filled with the generated water and the pressure of the generated water supplied to the first generated water injection nozzle 23 exceeds the first pressure value. Accordingly, most of the generated water present in the water storage tank 17 at the time point immediately preceding the initiation of the processing of Step S205 is injected from the first generated water injection nozzle 23 to the surface of the front camera 10. In a case where the spaces of the generated water pipeline 19, the first switching valve 20, the pump 21, and the first generated water injection pipeline 22 are not filled with the generated water at the initiation of the processing of Step S205, the generated water is injected from the first generated water injection nozzle 23 to the front camera 10 by a quantity substantially equal to A×B−C (cc) for the first predetermined time. In a case where the spaces of the generated water pipeline 19, the first switching valve 20, the pump 21, and the first generated water injection pipeline 22 are filled with the generated water at the initiation of the processing of Step S205, the generated water is injected from the first generated water injection nozzle 23 to the front camera 10 by a quantity substantially equal to A×B (cc) for the first predetermined time. As a result, the dirt that has adhered to the surface of the front camera 10 is washed away by the generated water.

Upon finishing the processing of Step S205, the ECU 38 proceeds to Step S206 and transmits the electric power of the secondary battery 36 to the air compressor 28 as the operation signal, via the drive circuit 37, and for a second predetermined time. Then, the air compressor 28 supplies compressed air to the compressed air pipeline 30 for the second predetermined time. Then, the compressed air is supplied to the first compressed air injection nozzle 32 via the compressed air pipeline 30 and the first compressed air injection pipeline 31. Then, the pressure of the compressed air supplied to the first compressed air injection nozzle 32 exceeds the second pressure value, and thus the compressed air is injected from the first compressed air injection nozzle 32 to the surface of the front camera 10. As a result, the generated water that adhered to the surface of the front camera 10 until then is removed from the surface of the front camera 10.

Accordingly, when the front camera 10 subsequently executes the imaging operation, the front camera 10 is capable of capturing a clear image of a subject positioned in front of the FC vehicle (such as another vehicle positioned in front of the FC vehicle).

The ECU 38 temporarily terminates the processing of this routine upon finishing the processing of Step S206.

The ECU 38 proceeds to Step S207 in the case of a No determination in Step S202. The ECU 38 makes a No determination in Step S202 when the ECU 38 executes the processing of Step S202 after executing the processing of Steps S203 to S206.

Upon proceeding to Step S207, the ECU 38 sets both the first switching valve 20 and the second switching valve 29 to the second state. In other words, the ECU 38 transmits the electric power of the secondary battery 36 as the operation signal via the drive circuit 37 to the first switching valve 20 and the second switching valve 29 and switches the first switching valve 20 and the second switching valve 29 from the first state to the second state in Step S207.

The ECU 38 proceeds to Step S208 and sets the valve flag to “zero” upon finishing the processing of Step S207.

Upon finishing the processing of Step S208, the ECU 38 proceeds to Step S205 and transmits the operation signal to the pump 21 via the drive circuit 37 for the first predetermined time. Then, the pump 21 operates for the first predetermined time and the pressure generated by the pump 21 causes the generated water present in the water storage tank 17 at the time point immediately preceding the initiation of the processing of Step S205 to be supplied to the second generated water injection nozzle 25 via the generated water pipeline 19 and the second generated water injection pipeline 24. Then, the inner spaces of the generated water pipeline 19 and the second generated water injection pipeline 24 are filled with the generated water and the pressure of the generated water supplied to the second generated water injection nozzle 25 exceeds the first pressure value. Accordingly, most of the generated water present in the water storage tank 17 at the time point immediately preceding the initiation of the processing of Step S205 is injected from the second generated water injection nozzle 25 to the surface of the rear camera 11. In a case where the spaces of the generated water pipeline 19, the first switching valve 20, the pump 21, and the second generated water injection pipeline 24 are not filled with the generated water at the initiation of the processing of Step S205, the generated water is injected from the second generated water injection nozzle 25 to the rear camera 11 by a quantity substantially equal to A×B−C (cc) for the first predetermined time. In a case where the spaces of the generated water pipeline 19, the first switching valve 20, the pump 21, and the second generated water injection pipeline 24 are filled with the generated water at the initiation of the processing of Step S205, the generated water is injected from the second generated water injection nozzle 25 to the rear camera 11 by a quantity substantially equal to A×B (cc) for the first predetermined time. As a result, the dirt that has adhered to the surface of the rear camera 11 is washed away by the generated water.

Upon finishing the processing of Step S205, the ECU 38 proceeds to Step S206 and transmits the operation signal to the air compressor 28 via the drive circuit 37 for the second predetermined time. Then, the air compressor 28 supplies compressed air to the compressed air pipeline 30 for the second predetermined time, and the compressed air is supplied to the second compressed air injection nozzle 34 via the compressed air pipeline 30 and the second compressed air injection pipeline 33. Then, the pressure of the compressed air supplied to the second compressed air injection nozzle 34 exceeds the second pressure value, and thus the compressed air is injected from the second compressed air injection nozzle 34 to the surface of the rear camera 11. As a result, the generated water that adhered to the surface of the rear camera 11 until then is removed from the surface of the rear camera 11.

Accordingly, when the rear camera 11 subsequently executes the imaging operation, the rear camera 11 is capable of capturing a clear image of a subject positioned behind the FC vehicle (such as a pedestrian positioned behind the FC vehicle).

The ECU 38 temporarily terminates the processing of this routine upon finishing the processing of Step S206.

As described above, according to the present embodiment, the ECU 38 operates the pump 21 in Step S205 and injects the generated water (substantially) on a regular basis toward the front camera 10 and the rear camera 11 once the ECU 38 determines in Step S201 that the quantity of the generated water in the water storage tank 17 is equal to or greater than the threshold water quantity. In other words, the ECU 38 immediately operates the pump, without considering the state of the dirt on the surfaces of the front camera 10 and the rear camera 11, once the quantity of the generated water in the water storage tank 17 becomes equal to or greater than the threshold water quantity. As described above, the threshold water quantity is set to a generated water quantity at which the dirt on the surface of the front camera 10 and the dirt on the surface of the rear camera 11 can be sufficiently removed. Since the generated water is injected to the front camera 10 and the rear camera 11 (substantially) on a regular basis, a large amount of dirt is unlikely to adhere to the surfaces of the front camera 10 and the rear camera 11. Accordingly, the threshold water quantity can be set to a small quantity. Accordingly, the capacity of the water storage tank 17 can be set small by the capacity of the water storage tank 17 being set to a capacity slightly exceeding the threshold water quantity. The capacity of the water storage tank 17 can be smaller than in a case where the cleaning system 15 is configured such that the generated water in the water storage tank 17 is simultaneously injected to the front camera 10 and the rear camera 11 from the first generated water injection nozzle 23 and the second generated water injection nozzle 25.

Although the present disclosure has been described based on the above embodiment, the present disclosure is not limited to the above embodiment and various modifications are possible without departing from the object of the present disclosure.

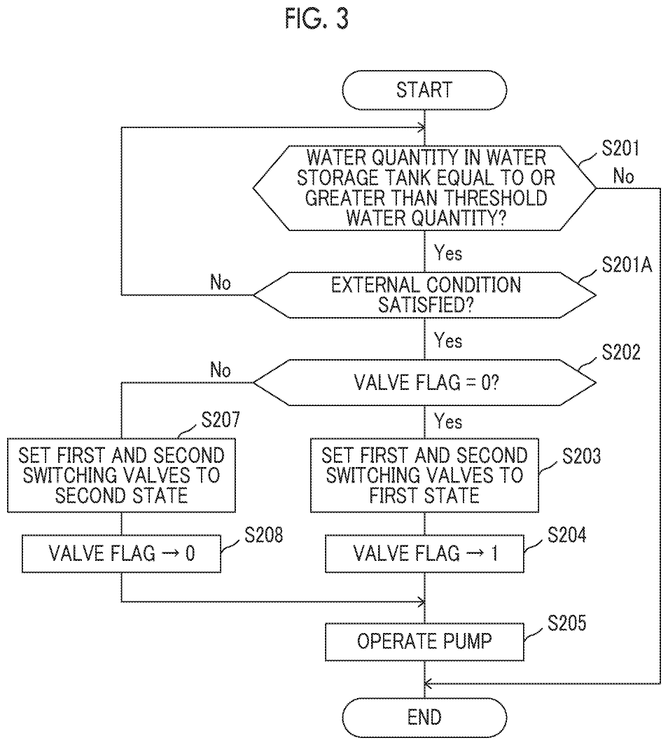

For example, the present disclosure may be implemented in the aspect of the modification example that is illustrated in FIG. 3. The flowchart of FIG. 3 is identical to the flowchart of FIG. 2 except that Step S201A is between Step S201 and Step S202 and Step S206 is omitted. The FC vehicle of the present modification example is not provided with the compressed air supply system 27.

In Step S201A, the ECU 38 determines whether or not a predetermined external condition is satisfied. The external condition is satisfied when the ECU 38 determines that the FC vehicle stops traveling for a predetermined needed transited time (such as one minute) or more from the current time. In the present embodiment, the ECU 38 does not execute the next processing of the flowchart until a time longer than the needed transited time transits in a case where the ECU 38 performs the processing of the flowchart of FIG. 3 once.

For example, a case is assumed where a traffic light changes from blue to red and the FC vehicle stops at an intersection after the FC vehicle travels up to the intersection where the traffic light and a roadside radio capable of wirelessly transmitting various types of information of the traffic light are installed. In this case, the roadside radio transmits, for example, information that “this traffic light will change from red to blue in 90 seconds” by wireless communication to the wireless receiver of the FC vehicle. Upon receiving the information, the ECU 38 of the FC vehicle determines that the external condition is satisfied based on the information received from the wireless receiver and makes a Yes determination in Step S201A.

Also assumed is a case where the FC vehicle is an automatic vehicle (AT vehicle) provided with a shift lever position switch detecting the position of a shift lever.

In this case, the ECU 38 determines that the external condition is satisfied and makes a Yes determination in Step S201A when, for example, the ECU 38 determines that “the position of the shift lever has changed from a position other than parking (P) to parking (P)” based on the information that is transmitted from the shift lever position switch.

The generated water is injected to the surfaces of the front camera 10 and the rear camera 11 once the ECU 38 executes the operation of Steps S203, S204, and S205 or the operation of Steps S207, S208, and S205 after making a Yes determination in Step S201A. In this case, no compressed air is injected to the surfaces of the front camera 10 and the rear camera 11. As described above, however, the ECU 38 does not execute the next processing of the flowchart until a time longer than the needed transited time (such as one minute) transits in a case where the ECU 38 performs the processing of the flowchart of FIG. 3 once. Accordingly, the generated water is likely to (almost) disappear from the surfaces of the front camera 10 and the rear camera 11 during the needed transited time due to the effect of gravity or the like even in the case of generated water injection to the front camera 10 or the rear camera 11 as a result of the processing of Step S205. Accordingly, the front camera 10 and the rear camera 11 are unlikely to become incapable of capturing a clear subject image due to the generated water adhered to the surfaces of the cameras during traveling of the FC vehicle despite the fact that the FC vehicle is not provided with the compressed air supply system 27.

The ECU 38 may determine whether or not the external condition is satisfied while considering the outside air temperature on the outer side of the FC vehicle. For example, the ECU 38 may determine that the external condition is satisfied when the ECU 38 determines that the FC vehicle stops traveling for the needed transited time or more from the current time and the outside air temperature is higher than 0° C. (freezing point of water). In this case, the FC vehicle may detect the outside air temperature with, for example, a temperature sensor provided at a part of the body of the vehicle (such as the front grill). The FC vehicle may acquire the outside air temperature by using means for externally acquiring information relating to the weather in the region where the FC vehicle is positioned and the vicinity of the region (such as means wirelessly connected to the Internet). According to this modification example, the generated water adhered to the surfaces of the front camera 10 and the rear camera 11 does not freeze. Accordingly, the front camera 10 and the rear camera 11 do not capture any unclear subject image attributable to frozen generated water (ice) during the imaging operation of the front camera 10 and the rear camera 11.

Cleaning objects that are cleaned by the generated water are not limited to the front camera 10 and the rear camera 11. The cleaning objects may include at least one of cameras in the side portions of the FC vehicle (such as side mirrors) or cameras in the right and left end portions of the front portion of the FC vehicle.

Solely one cleaning object (such as the front camera 10) may be cleaned.

The number of the cleaning objects that the FC vehicle is provided with may be three or more. Even in a case where the number of the cleaning objects is three or more, the generated water in the water storage tank 17 is injected from one generated water injection nozzle to one cleaning object once the generated water accumulated in the water storage tank 17 becomes equal to or greater than the threshold water quantity. Once the generated water accumulated in the water storage tank 17 subsequently becomes equal to or greater than the threshold water quantity, the generated water in the water storage tank 17 is injected from one generated water injection nozzle to another cleaning object. In other words, even in a case where the number of the cleaning objects is three or more, the generated water accumulated in the water storage tank 17 is not simultaneously injected to all of the cleaning objects.

In a case where the number of the cleaning objects is three or more, the generated water may be simultaneously injected to a plurality of the cleaning objects smaller in number than the total number. In a case where the number of the cleaning objects is five, for example, the generated water in the water storage tank 17 may be simultaneously injected to two of the cleaning objects once the generated water accumulated in the water storage tank 17 becomes equal to or greater than the threshold water quantity.

In a case where the number of the cleaning objects is two or more, each of a plurality of pipelines independent of each other may have an end connected to the water storage tank 17 and each of the pipelines may be provided with a pump and a generated water injection nozzle.

A compressor may be connected to a pipeline with a generated water injection nozzle connected to the tip of the pipeline. In this case, the generated water and the compressed air are simultaneously injected to the cleaning object from the generated water injection nozzle. Accordingly, in this case, the generated water injected to the cleaning object removes dirt from the cleaning object and is removed from the cleaning object by the pressure of the compressed air at the same time.

What is claimed is:

1. A fuel cell vehicle comprising:
an electric motor configured to generate a drive force for rotating a drive wheel of the fuel cell vehicle;
a fuel cell configured to generate electric power to be supplied to the electric motor by causing a chemical reaction between hydrogen and oxygen;
a water storage tank configured to store generated water generated when the fuel cell generates the electric power;
a water quantity detector configured to detect a quantity of the generated water in the water storage tank;
a generated water injection nozzle connected to the water storage tank via a pipeline and disposed so as to face a cleaning object provided at a part of the fuel cell vehicle;
a pump configured to supply the generated water in the water storage tank to the generated water injection nozzle via the pipeline; and
a pump control device configured to control the pump such that the generated water is supplied to the generated water injection nozzle and the generated water is injected from the generated water injection nozzle toward the cleaning object when the pump control device determines that the quantity of the generated water detected by the water quantity detector has become equal to or greater than a predetermined threshold water quantity.

2. The fuel cell vehicle according to claim 1, wherein:
the fuel cell vehicle is provided with a plurality of the cleaning objects;
the fuel cell vehicle is provided with a plurality of the generated water injection nozzles, the generated water injection nozzles are disposed such that each of the generated water injection nozzles faces a corresponding one of the cleaning objects; and
the pump control device is configured to control the pump such that the generated water is supplied to a part of the generated water injection nozzles and the generated water is injected from the part of the generated water injection nozzles toward a part of the cleaning objects when the pump control device determines that the quantity of the generated water detected by the water quantity detector has become equal to or greater than the predetermined threshold water quantity.

3. The fuel cell vehicle according to claim 1, further comprising:
a compressed air injection nozzle disposed so as to face the cleaning object and connected to an air compressor via an air pipeline; and
a compressor control device configured to control the air compressor such that compressed air is pumped to the compressed air injection nozzle and the compressed air is injected from the compressed air injection nozzle toward the cleaning object after the generated water is injected toward the cleaning object by the generated water injection nozzle.

4. The fuel cell vehicle according to claim 1, further comprising:
an air compressor connected to the generated water injection nozzle via the pipeline; and
a compressor control device configured to control the air compressor such that compressed air is injected from the generated water injection nozzle toward the cleaning object by the compressed air being pumped to the generated water injection nozzle simultaneously with the injection of the generated water by the generated water injection nozzle.

5. The fuel cell vehicle according to claim 1, wherein the pump control device is configured to control the pump such that the generated water is supplied to the generated water injection nozzle and the generated water is injected from the generated water injection nozzle toward the cleaning object when the pump control device determines that the quantity of the generated water detected by the water quantity detector has become equal to or greater than the predetermined threshold water quantity and the fuel cell vehicle stops for a predetermined needed transited time.
